(19) United States
(12) Patent Application Publication
(10) Pub. No.: US 2024/0250591 A1
(43) Pub. Date: Jul. 25, 2024

(54) SYSTEM FOR FIELD ALIGNMENT OF TANDEM PERMANENT MAGNET MOTORS

(71) Applicant: Baker Hughes Oilfield Operations LLC, Houston, TX (US)

(72) Inventors: Mark Bellmyer, Broken Arrow, OK (US); Chad Craig, Owasso, OK (US); David Tanner, Broken Arrow, OK (US); Charles Collins, Edmond, OK (US); Ryan Semple, Owasso, OK (US)

(73) Assignee: Baker Hughes Oilfield Operations LLC, Houston, TX (US)

(21) Appl. No.: 18/420,618

(22) Filed: Jan. 23, 2024

Related U.S. Application Data
(60) Provisional application No. 63/440,669, filed on Jan. 23, 2023.

(51) Int. Cl. H02K 16/00; H02K 5/132

(52) U.S. Cl. CPC H02K 16/00; H02K 5/132

(57) ABSTRACT

A method of assembling a tandem permanent magnet motor includes the steps of using an external visual reference system to align the stator assembly of the upper permanent magnet motor with the stator assembly of the lower permanent magnet motor. The external visual reference system includes a series of external reference marks that provide a mechanism for quickly aligning the upper and lower permanent magnet motors in the field prior to installation in a well as part of an electric submersible pumping system.

### RELATED APPLICATIONS

The present application claims the benefit of U.S. Provisional Patent Application Ser. No. 63/440,669 filed Jan. 23, 2023 and entitled “System for Field Alignment of Tandem Permanent Magnet Motors,” the disclosure of which is herein incorporated by reference.

### FIELD OF THE INVENTION

This disclosure relates generally to the field of electric submersible pumping systems, and more particularly, but not by way of limitation, to an improved system and method for aligning tandem permanent magnet motors in the field prior to deployment.

### BACKGROUND OF THE INVENTION

Pumping systems are often deployed into wells to recover petroleum fluids from subterranean reservoirs. Typically, the submersible pumping system includes a number of components, including one or more electric motors coupled to one or more high performance pumps. Most electric submersible pumping (ESP) systems employ conventional induction motors to drive the pump. The induction, or “squirrel cage,” motors tend to be long, which can present deployment problems in certain applications, including deviated wellbores and surface applications with limited space.

In other applications, ESP systems make use of a permanent-magnet motor rather than an induction motor. In a permanent magnet motor, a long motor shaft extends through several rotor sections that are coupled to the shaft. Each of the rotor sections includes a set of permanent magnets that are typically positioned in multiple (e.g., four) axially aligned rows. The shaft and rotor sections are positioned within a stator. The stator has several coils or windings of wire positioned in a stator core. When the coils are energized, the windings generate magnetic fields that interact with the magnets of the rotor sections. The power provided to the stator windings is controlled to cause the magnetic fields of the stator to drive the rotor sections to rotate within the stator, thereby driving the rotation of the shaft. The rotating shaft is coupled to the ESP's pump and drives the pump to lift fluid out of the well.

Unlike induction motors, permanent magnet motors depend on precise phase alignment between the rotor and the stator. When connecting two permanent magnet motors together in a “tandem” series configuration, it is important to properly align the phases of the rotors and stators of both motors. Because the tandem motors are typically bolted together at the wellsite before being lowered into the well, there exists a need for a system and method for aligning the rotors and stators in the field during the installation process.

### SUMMARY OF THE INVENTION

In some embodiments, the present disclosure is directed to a method of assembling a tandem motor that includes an upper permanent magnet motor and lower permanent magnet motor. The method includes the steps of using an external visual reference system to align an upper housing and upper stator assembly of the upper permanent magnet motor with an upper base, using the external visual reference system to align a lower housing and lower stator assembly of the lower permanent magnet motor with a lower head, and connecting the upper base to the lower head.

In other embodiments, the present disclosure is directed to a method of assembling a tandem motor that includes an upper permanent magnet motor and lower permanent magnet motor. The method includes the steps of threading an upper locking ring into an upper housing of the upper permanent magnet motor, threading an upper stator adapter into the upper housing, unthreading the upper stator adapter until an upper reference mark on the upper stator adapter is aligned with an upper housing reference mark, and unthreading the upper locking ring until it contacts the upper base to lock the upper base into a fixed position relative to the upper housing. Next, the method includes the steps of attaching an upper base to the upper base stator adapter such that an upper reference mark on the upper base is aligned with a lower reference mark on the upper stator adapter. The method continues with the step of threading a lower locking ring into a lower housing of the lower permanent magnet motor, threading a lower stator adapter into the lower housing, and unthreading the lower stator adapter until a lower reference mark on the lower stator adapter is aligned with a lower housing reference mark. The method continues with the steps of unthreading the lower locking ring until it contacts the lower stator adapter to lock the lower stator adapter into a fixed position relative to the lower housing. Next, the method includes the steps of attaching a lower head to the lower stator adapter such that a lower reference mark on the lower head is aligned with a lower stator adapter upper reference mark, rotating the lower permanent magnet motor relative to the upper permanent magnet motor until a lower head upper reference mark on the lower head is aligned with a lower reference mark on the upper base, and connecting the lower head to the upper base.

In another aspect, the present disclosure is directed at a tandem permanent magnet motor that includes an upper permanent magnet motor and a lower permanent magnet motor. The upper permanent magnet motor includes an upper housing having an external upper housing reference mark, an upper stator adapter having an upper stator adapter upper reference mark and an upper stator adapter lower reference mark, and an upper locking ring configured to lock the upper stator adapter in angular alignment with the upper housing such that the upper stator adapter upper reference mark is aligned with the upper housing reference mark. The lower permanent magnet motor includes a lower housing having an external lower housing reference mark, a lower stator adapter having a lower stator adapter upper reference mark and a lower stator adapter lower reference mark, and a lower locking ring configured to lock the lower stator adapter in angular alignment with the lower housing such that the lower stator adapter lower reference mark is aligned with the lower housing reference mark.

### BRIEF DESCRIPTION OF DRAWINGS

FIG. 1 is a side view of a pumping system constructed in accordance with an exemplary embodiment.

FIGS. 2A-2B are cross-sectional views of the tandem permanent magnet motors of the pumping system of FIG. 1.

FIG. 3 is a cross-sectional perspective view of a portion of the upper end of the lower motor showing the installation of the lower locking ring.

FIG. 4 is a cross-sectional perspective view of a portion of the upper end of the lower motor showing the initial installation of the lower stator adapter.

FIG. 5 is a cross-sectional perspective view of a portion of the upper end of the lower motor showing the angular adjustment of the lower stator adapter with the lower housing.

FIG. 6 is a cross-sectional perspective view of a portion of the upper end of the lower motor showing the step of locking the lower stator adapter into aligned registration with the lower housing.

FIG. 7 is a cross-sectional perspective view of a portion of the upper end of the lower motor showing the connection of the lower head to the lower stator adapter.

FIG. 8 is a partial side view of the pumping system showing the external visual reference system used to align the components within the pumping system.

### DETAILED DESCRIPTION

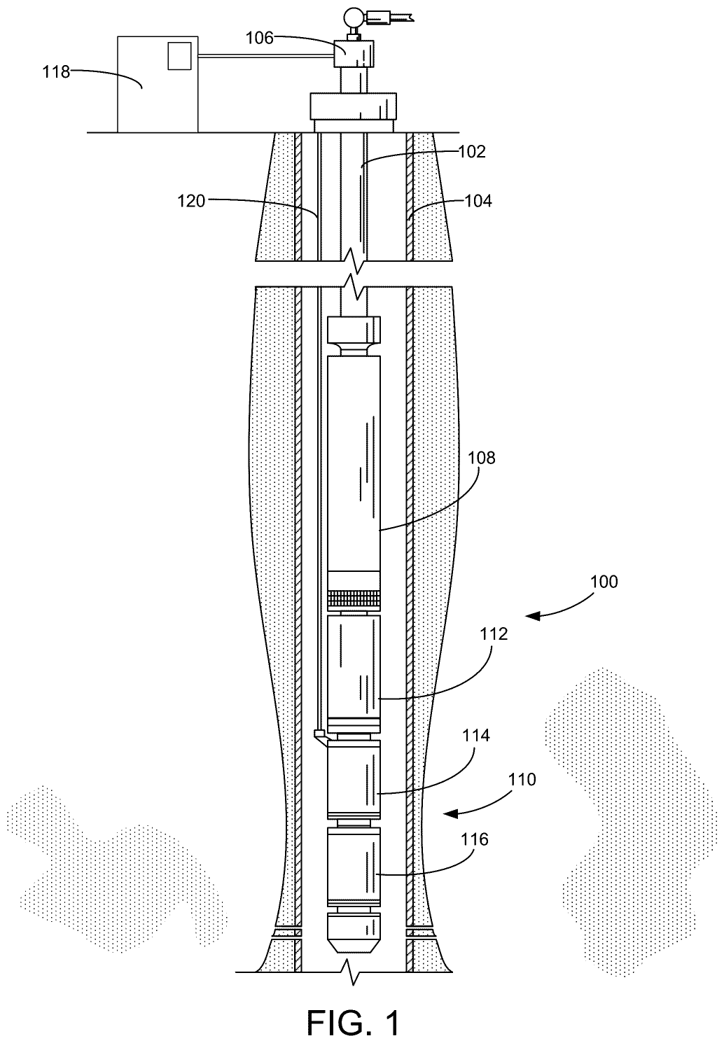

In accordance with exemplary embodiments of the present invention, FIG. 1 shows a perspective view of a pumping system 100 attached to production tubing 102. The pumping system 100 and production tubing 102 are disposed in a wellbore 104, which is drilled for the production of a fluid such as water or petroleum. As used herein, the term “petroleum” refers broadly to all mineral hydrocarbons, such as crude oil, gas and combinations of oil and gas. The production tubing 102 connects the pumping system 100 to a wellhead 106 located on the surface. Although the pumping system 100 is primarily designed to pump petroleum products, it will be understood that the present invention can also be used to move water or other fluids. It will also be understood that, although the pumping system 100 of FIG. 1 is depicted in a vertical wellbore 104, the systems and methods disclosed herein will also find utility in non-vertical wellbores and surface pumping applications.

The pumping system 100 includes a pump 108, a tandem motor 110, and a seal section 112. The tandem motor 110 includes an upper permanent magnet motor 114 connected to a lower permanent magnet motor 116, which each receive power from surface-based drive 118 through a power cable 120. The lower permanent magnet motor 116 can receive power through an external or internal electrical connection with the power cable 120 or upper permanent magnet motor 114. When energized, the upper permanent magnet motor 114 and lower permanent magnet motor 116 generate torque that is transferred to the pump 108 through a series of interconnected shafts.

The seal section 112 shields the tandem motor 110 from mechanical thrust produced by the pump 108 and provides for the expansion and contraction of motor lubricants during operation. The seal section 112 also isolates the tandem motor 110 from the wellbore fluids passing through the pump 108.

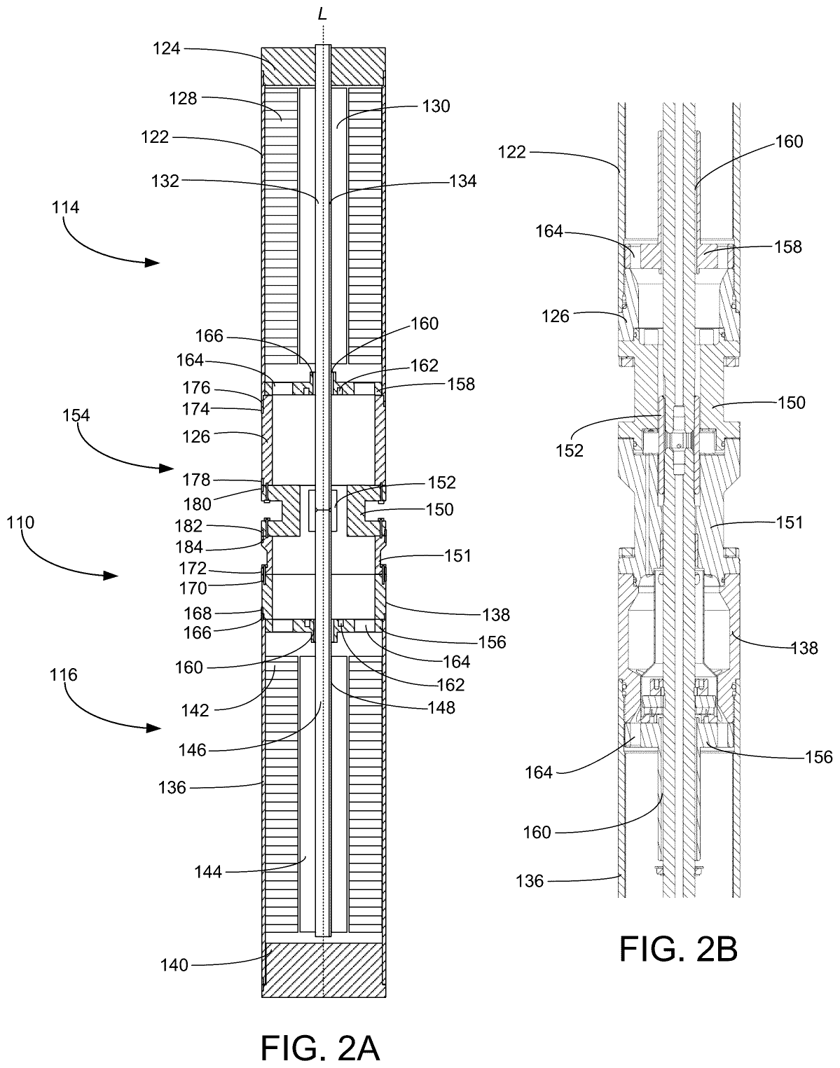

Turning to FIG. 2A, shown therein is a simplified cross-sectional depiction of an embodiment of the tandem motor 110. FIG. 2B provides a close-up cross-sectional view of an alternate embodiment of the tandem motor 110 illustrating the connection between the upper and lower tandem permanent magnet motors 114, 116. The upper permanent magnet motor 114 includes an upper housing 122, an upper head 124, an upper stator adapter 126 and an upper base 150. The upper housing 122 extends between the upper head 124 and the upper stator adapter 126 to enclose the interior components of the upper permanent magnet motor 114, which include an upper stator assembly 128 and an upper rotor assembly 130. The upper head 124 and the upper stator adapter 126 are each configured for a threaded engagement with the interior of the upper housing 122. The upper base 150 is similarly configured for a threaded engagement with the upper stator adapter 126.

The upper stator assembly 128 includes a series of magnet wire windings that form a series of coils within the upper stator assembly 128, where each series of coils corresponds to a separate electrical phase. The upper rotor assembly 130 includes a plurality of permanent magnets. During manufacture, the upper rotor assembly 130 is connected to an upper motor shaft 132, which extends through the upper permanent magnet motor 114. The upper motor shaft 132 includes an engagement feature 134 that locks the upper rotor assembly 130 into angular alignment with the upper motor shaft 132. In some embodiments, the engagement feature 134 is a slot that is configured to accept a mating key within the upper rotor assembly 130. In other embodiments, the engagement feature 134 is a key that is accepted by a corresponding slot in the upper rotor assembly 130. Thus, the angular position of the upper rotor assembly 130 is fixed to the upper motor shaft 132 during manufacture before the upper permanent magnet motor 114 is delivered to the field.

Likewise, the lower permanent magnet motor 116 includes a lower housing 136, a lower stator adapter 138, a lower head 151 and a lower base 140. The lower housing 136 extends between the lower stator adapter 138 and the lower base 140 to enclose the interior components of the lower magnet motor 116, which include a lower stator assembly 142 and a lower rotor assembly 144. The lower stator adapter 138 and the lower base 140 are each configured for a threaded engagement with the interior of the lower housing 136. The lower head 151 is similarly configured for a threaded engagement with the lower stator adapter 138.

The lower stator assembly 142 includes a series of magnet wire windings that form a series of coils within the lower stator assembly 142, where each series of coils corresponds to a separate electrical phase. The lower rotor assembly 144 includes a plurality of permanent magnets. During manufacture, the lower rotor assembly 144 is connected to a lower motor shaft 146, which extends through the lower permanent magnet motor 116. The lower motor shaft 146 includes an engagement feature 148 that locks the lower rotor assembly 144 into angular alignment with the lower motor shaft 146. In some embodiments, the engagement feature 148 is a slot that is configured to accept a mating key within the lower rotor assembly 144. In other embodiments, the engagement feature 148 is a key that is accepted by a corresponding slot in the lower rotor assembly 144. Thus, the angular position of the lower rotor assembly 144 is fixed to the lower motor shaft 146 during manufacture before the lower permanent magnet motor 116 is delivered to the field.

The upper permanent magnet motor 114 can be connected to the lower permanent magnet motor 116 by bolting the upper base 150 to the lower head 151. In other embodiments, a motor adapter replaces or connects the upper base 150 and lower head 151. The connection of the upper permanent magnet motor 114 to the lower permanent magnet motor 116 typically takes place in the field before the pumping system 100 is installed in the wellbore 104. The upper base 150 is bolted to the lower head 151. A shaft coupling 152 can be used to connect the upper motor shaft 132 to the lower motor shaft 146. In exemplary embodiments, the shaft coupling 152 includes one or more keys or slots that align the upper motor shaft 132 with the lower motor shaft 146 such that the upper rotor assembly 130 and lower rotor assembly 144 are precisely aligned with one another.

When the windings within the upper stator assembly 128 and lower stator assembly 142 are energized, the resulting magnetic fields force the upper rotor assembly 130 and lower rotor assembly 144 to rotate in accordance with established electromechanical principles. Because the same phased electrical power is provided to both the upper permanent magnet motor 114 and the lower permanent magnet motor 116, it is important to ensure the proper angular alignment between the upper stator assembly 128 and the lower stator assembly 142.

As used herein, the term “angular alignment” refers to the alignment of components within the pumping system 100 with reference to a polar coordinate system centered on and orthogonal to a primary longitudinal axis (L) that extends through the substantially cylindrical pumping system 100. In this way, the relative angular positions of two components within the pumping system 100 can be adjusted by rotating one component relative to the other component along the longitudinal axis (L) extending through the pumping system 100.

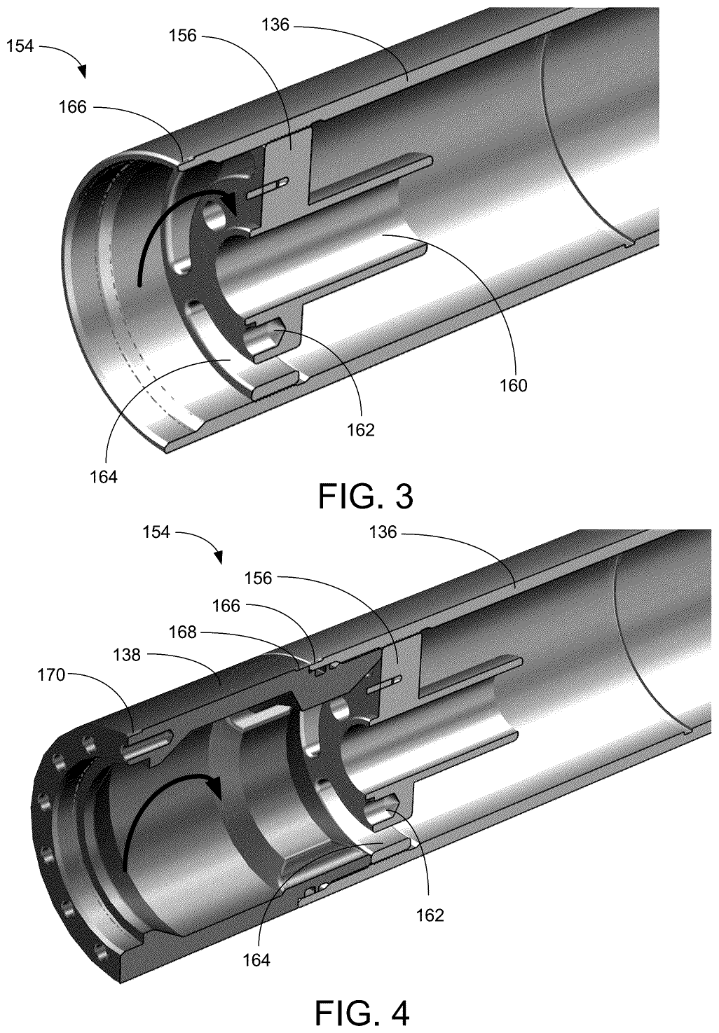

Turning to FIGS. 3-7, shown therein are depictions of the process of using an external visual reference system 154 to align the various components of the tandem motor 110. Although the process is depicted with reference to the alignment of the lower head stator adapter 138 and lower head 151, it will be appreciated that the same process is also carried out on the upper base 150 and upper stator adapter 126. As described below, the external visual reference system 154 includes a series of externally visible “reference marks” on the upper housing 122, upper stator adapter 126, upper base 150, lower stator adapter 138, lower housing 136 and lower head 151. In each case, the reference marks can be grooves, notches, scores or other visible indicia that can be visibly placed into angular alignment with an adjacent reference mark.

Beginning with FIG. 3, the lower permanent magnet motor 116 includes a lower locking ring 156, which is threaded into the lower housing 136 before the lower stator adapter 138 has been installed. The lower locking ring 156 includes a shaft passage 160 for the lower motor shaft 146, torque tool bores 162, and conduit passages 164 for making internal electrical connections between the upper permanent magnet motor 114 and lower permanent magnet motor 116, as well as providing a passage for the circulation of motor lubricants. As noted in FIGS. 2A and 2B, the upper permanent magnet motor 114 includes an upper locking ring 158 with the same features as the lower locking ring 156.

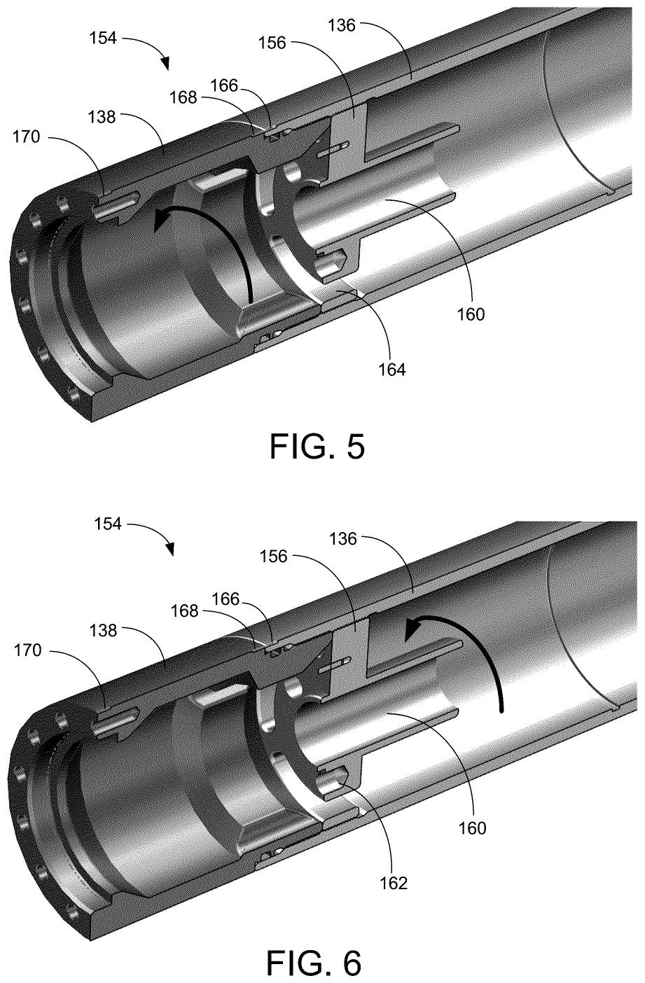

In FIG. 4, the lower stator adapter 138 is threaded into the lower housing 136 until the flange of the lower stator adapter 138 contacts the end of the lower housing 136. The lower housing 136 includes a lower housing reference mark 166 on the exterior of the lower housing 136. The lower stator adapter 138 includes a lower stator adapter lower reference mark 168 and a lower stator adapter upper reference mark 170. In FIG. 5, the lower stator adapter 138 is rotated in threaded engagement with the lower housing 136 until the lower stator adapter lower reference mark 168 is aligned with the lower housing reference mark 166. In some cases, the lower stator adapter 138 is aligned with the lower housing 136 by counter-rotating (unthreading) the lower stator adapter 138 by a small degree of angular rotation that does not compromise the seal between the lower stator adapter 138 and the lower housing 136.

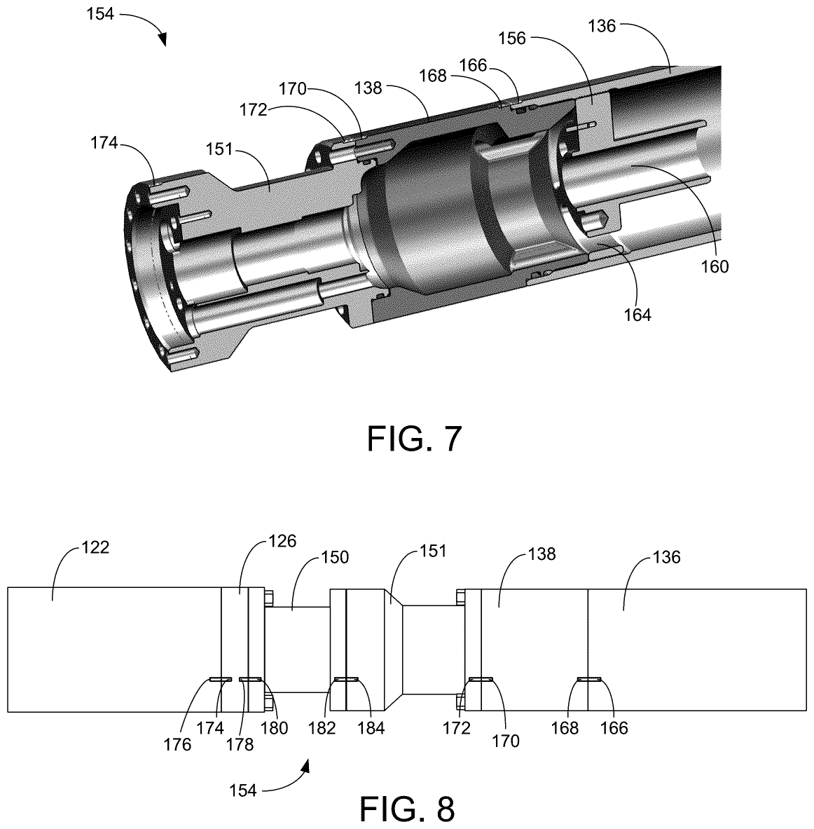

Once the lower stator adapter 138 has been aligned with the lower housing 136, a torque tool (not shown) is inserted through the lower stator adapter 138 to engage the torque tool bores 162 of the lower locking ring 156. The torque tool extends out of the lower housing 136 such that a torque can be applied to the lower locking ring 156. As illustrated in FIG. 6, the lower locking ring 156 is then counter-rotated until it contacts the lower stator adapter 138. Sufficient torque is applied to the lower locking ring 156 to lock the lower locking ring 156 and the lower stator adapter 138 in a fixed position with respect to the lower housing 136, thereby locking the lower housing 136 and lower stator adapter 138 in proper registration. The force applied by the lower locking ring 156 to the lower stator adapter 138 prevents the lower stator adapter 138 from unthreading from the lower housing 136. As depicted in FIG. 7, the lower head 151 can then be bolted to the lower stator adapter 138 such that a lower head lower reference mark 172 aligns with a lower stator adapter upper reference mark 170.

The same process is repeated for the upper permanent magnet motor 114. The upper locking ring 158 is threaded into the lower end of the upper housing 122. The upper stator adapter 126 is rotated in threaded engagement with the upper housing 122 and then counter-rotated (or unthreaded) a small amount until an upper stator adapter upper reference mark 174 is angularly aligned with an upper housing reference mark 176. The upper locking ring 158 can then be counter-rotated into contact with the upper stator adapter 126 to fix the angular alignment of the upper stator adapter 126 to the upper housing 122. The upper base 150 can then be connected to the upper stator adapter 126 such that an upper stator adapter lower reference mark 178 is aligned with an upper base upper reference mark 180.

As depicted in FIG. 8, once the upper base 150 and lower head 151 have been respectively locked into alignment with the upper housing 122 and the lower housing 136, the upper base 150 can be connected to the lower head 151 such that an upper base lower reference mark 182 aligns with a lower head upper reference mark 184. This may require rotating the entire assembled lower permanent magnet motor 116 into alignment with the upper permanent magnet motor 114. The lower head 151 can be secured to the upper base 150 with bolts or other fasteners captured in pre-drilled holes in the lower head 151 and upper base 150.

In other embodiments, the upper base 150 is preliminarily connected to the lower head 151 before the upper base 150 is locked into angular alignment with the upper housing 122. The upper base 150 can then be temporarily disconnected from the lower head 151. The torque tool can be configured to pass through the upper base 150 and the upper stator adapter 126 to reach the upper locking ring 158. The upper housing 122 can then be rotated into alignment with the upper stator adapter 126 and locked into position with the upper locking ring 158. The upper housing 122 and locked upper stator adapter 126 can then be rotated into alignment with the upper base 150, which remains disconnected from, but in registry with, the lower head 151. Once the upper stator adapter 126 has been reconnected to the upper base 150, the upper base 150 can be reconnected to the lower head 151.

Thus, the tandem motor 110 includes an external visual reference system 154 that facilitates the proper alignment of the upper and lower permanent magnet motors 114, 116 through the use of visual reference marks on the outside of the tandem motor 110. The external visual reference system 154 generally provides a mechanism for confirming the proper registration between the upper and lower stator assemblies 128, 142 as the tandem motor 110 is being assembled in the field. Using the external visual reference system 154, the upper stator adapter 126 and upper base 150 can be precisely rotated into alignment with the upper housing 122 and upper stator assembly 128, and then locked into position with the upper locking ring 158.

Similarly, the lower stator adapter 138 can be rotated into alignment with the lower stator assembly 142 and lower housing 136 and then locked into position with the lower locking ring 156. Once the lower stator adapter 138 and lower head 151 have been properly aligned with the lower housing 136 and lower stator assembly 142, the lower permanent magnet motor 116 can be approximated and rotated into alignment with the upper permanent magnet motor 114 using the external visual reference system 154. It will be appreciated the alignment process can alternatively be carried out by aligning the lower stator adapter 138 with the lower stator assembly 142, connecting the upper base 150 to the lower head 151, aligning the upper base 150 to the upper stator assembly 128, and then connecting the upper permanent magnet motor 114 to the lower permanent magnet motor 116.

The combination of the external visual reference system 154 and the lower and upper locking rings 156, 158 provides a robust mechanism for precisely aligning the upper stator assembly 128 and the lower stator assembly 142 in the field prior to installation of the pumping system 100. The upper base 150 and lower head 151 serve essentially as fixed reference points to which the upper housing 122 and lower housing 136 can be aligned using the external visual reference system 154. The lower and upper locking rings 156, 158 permit fine adjustments to the angular alignment of the upper housing 122 and upper stator assembly 128 with the lower housing 136 and lower stator assembly 142 that would not be possible if the upper and lower housings 122, 136 could only be rotated in angular increments that match the spacing of bolt holes between the upper base 150 and lower head 151. The external visual reference system 154 facilitates the exact alignment of the upper and lower permanent magnet motors 114, 116 in the field.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. It will be appreciated by those skilled in the art that the teachings of the present invention can be applied to other systems without departing from the scope and spirit of the present invention.

It is claimed:

1. A method of assembling a tandem motor that includes an upper permanent magnet motor and lower permanent magnet motor, the method comprising the steps of:
using an external visual reference system to align an upper housing and upper stator assembly of the upper permanent magnet motor with an upper base;
using the external visual reference system to align a lower housing and lower stator assembly of the lower permanent magnet motor with a lower head; and
connecting the upper base to the lower head.

2. The method of claim 1, wherein the step of using an external visual reference system to align the upper housing and upper stator assembly with the upper base further comprises the step of:
using the external visual reference system to connect an upper stator adapter in proper alignment with the upper housing; and
using the external visual reference system to connect the upper base to the upper stator adapter.

3. The method of claim 2, wherein the step of using the external visual reference system to connect the upper stator adapter in proper alignment with the upper housing further comprises the step of locking the upper stator adapter in proper alignment with the upper housing with an upper locking ring.

4. The method of claim 3, wherein the step of using an external visual reference system to align the lower housing and lower stator assembly with the lower head further comprises the step of:
using the external visual reference system to connect a lower stator adapter in proper alignment with the lower housing; and
using the external visual reference system to connect the lower head to the lower stator adapter.

5. The method of claim 4, wherein the step of using the external visual reference system to connect the lower stator adapter in proper alignment with the lower housing further comprises the step of locking the lower stator adapter in proper alignment with the lower housing with a lower locking ring.

6. A method of assembling a tandem motor that includes an upper permanent magnet motor and lower permanent magnet motor, the method comprising the steps of:
threading an upper locking ring into an upper housing of the upper permanent magnet motor;
threading an upper stator adapter into the upper housing;
unthreading the upper stator adapter until an upper stator adapter upper reference mark on the upper stator adapter is aligned with an upper housing reference mark on the upper housing;
unthreading the upper locking ring until it contacts the upper stator adapter to lock the upper stator adapter into a fixed position relative to the upper housing; and
attaching an upper base to the upper stator adapter such that an upper base upper reference mark on the upper base is aligned with an upper stator adapter lower reference mark on the upper stator adapter.

7. The method of claim 6, further comprising the steps of:
threading a lower locking ring into a lower housing of the lower permanent magnet motor;
threading a lower stator adapter into the lower housing;
unthreading the lower stator adapter until a lower stator adapter lower reference mark on the lower stator adapter is aligned with a lower housing reference mark on the lower housing;
unthreading the lower locking ring until it contacts the lower stator adapter to lock the lower stator adapter into a fixed position relative to the lower housing; and
attaching a lower head to the lower stator adapter such that a lower head lower reference mark on the lower head is aligned with a lower stator adapter upper reference mark on the lower stator adapter.

8. The method of claim 7, further comprising the steps of:
rotating the lower permanent magnet motor relative to the upper permanent magnet motor until a lower head upper reference mark on the lower head is aligned with an upper base lower reference mark on the upper base; and
connecting the lower head to the upper base.

9. A tandem permanent magnet motor comprising:
an upper permanent magnet motor, wherein the upper permanent magnet motor comprises:
an upper housing that includes an upper housing reference mark on the outside of the upper housing; and
an upper base that includes an upper base upper reference mark and an upper base lower reference mark on the outside of the upper base; and
a lower permanent magnet motor, wherein the lower permanent magnet motor comprises:
a lower housing that includes a lower housing reference mark on the outside of the lower housing; and
a lower head that includes a lower head upper reference mark and a lower head lower reference mark on the outside of the lower head.

10. The tandem permanent magnet motor of claim 9, wherein the upper permanent magnet motor further comprises an upper stator adapter between the upper housing and the upper base, and wherein the upper stator adapter has an upper stator adapter upper reference mark and an upper stator adapter lower reference mark on the outside of the upper stator adapter.

11. The tandem permanent magnet motor of claim 10, wherein the upper stator adapter upper reference mark is aligned with the upper housing reference mark, and wherein the upper stator adapter lower reference mark is aligned with the upper base upper reference mark.

12. The tandem permanent magnet motor of claim 11, further comprising an upper locking ring inside the upper housing adjacent to the upper stator adapter, wherein the upper locking ring locks the upper stator adapter into fixed rotational alignment with the upper housing.

13. The tandem permanent magnet motor of claim 9, wherein the lower permanent magnet motor further comprises a lower stator adapter between the lower housing and the lower head, and wherein the lower stator adapter has a lower stator adapter upper reference mark and a lower stator adapter lower reference mark on the outside of the lower stator adapter.

14. The tandem permanent magnet motor of claim 12, wherein the lower stator adapter lower reference mark is aligned with the lower housing reference mark, and wherein the lower stator adapter upper reference mark is aligned with the lower head lower reference mark.

15. The tandem permanent magnet motor of claim 14, further comprising a lower locking ring inside the lower housing adjacent to the lower stator adapter, wherein the lower locking ring locks the lower stator adapter into fixed rotational alignment with the lower housing.

16. The tandem permanent magnet motor of claim 15, wherein the upper base is connected to the lower head such that the upper base lower reference mark is aligned with the lower head upper reference mark.
